(19) United States
(12) Patent Application Publication
(10) Pub. No.: US 2020/0165854 A1
(43) Pub. Date: May 28, 2020

(54) RECREATIONAL VEHICLE AS WELL AS AN OPENING DEVICE AND COUPLING DEVICE FOR USE THEREIN

(71) Applicant: POLYPLASTIC GROEP B.V., Rotterdam (NL)

(72) Inventor: Jan Peter VEENEMAN, Bergschenhoek (NL)

(21) Appl. No.: 16/615,063

(22) PCT Filed: May 18, 2018
(86) PCT No.: PCT/NL2018/050336

§ 371 Date: Nov. 19, 2019

(30) Foreign Application Priority Data
May 19, 2017 (NL) 2018954

(51) Int. Cl. E05F 1/10

(52) U.S. Cl. CPC E05F 1/1091; E05F 15/622; E05F 1/1058

(57) ABSTRACT

A recreational vehicle comprises a space enclosed by walls (1), wherein at least one of the walls comprises an openable panel, such as for instance a window (20). Provided between the window (20) and the wall (1) is an opening device (30) which is connected pivotally to the window on one side and extends pivotally from the wall of the window opening (2) on the other. Provided here between the wall (1) and the opening device is a ball joint or ball hinge between on one side a ball cup (35) and on the other a ball head (45) which extend from a coupling device (40) and the opening device (30).

The present invention relates to a recreational vehicle comprising a space enclosed by walls, wherein at least one of the walls is provided with a wall opening recessed therein and surrounded by an edge with an openable panel which is adjustable between a closed state closing off the opening and at least one wholly or partially opened state, which panel is provided with at least one opening device with which the panel is fixable in the at least one wholly or partially opened state, wherein the opening device comprises a proximal end and an opposite distal end and is connected at the distal end to the window.

The invention relates particularly here to a recreational vehicle such as a caravan or camper, also referred to as a mobile home. Such an accommodation is characterized by walls formed from sandwich panels. These panels comprise an insulating core of polymer foam on either side of which a covering is arranged. On an outer side this is usually aluminium or plastic, while on the inside, with comfort and aesthetics in mind, a wood veneer or wood fibre panel is often applied. Normally provided in the walls of such an accommodation are one or more openable panels, in particular openable windows, which can usually be opened to different positions or closed as desired. An opening device serves to hold the window in a wholly or partially opened state. This is connected hingedly at a distal end to the window and in the known accommodation connected at a proximal end for plane-parallel pivoting to the edge of the wall opening. Through a length adjustment of the opening device the window can thus be opened to different intermediate positions until the maximum length of the opening device has been reached, wherein the hinged attachment at both ends provides for the required freedom of movement.

The openable panel is normally mounted in one of the final steps of the manufacture of a recreational vehicle. The window is hung here from an outer side in a hinge profile provided for the purpose, and the opening device is also arranged. The opening device has for this purpose to be mounted respectively on the window and close to the edge of the wall opening. The wall mounting is normally realized by means of screwing. A drawback of such a final assembly is however not only that screwing into the wall is time-consuming but also that for this purpose it is necessary to enter the accommodation at a relatively late stage of completion. This entails the risk of damage to the interior of the accommodation, which at that moment will usually be at an advanced stage of manufacture.

The present invention has for its object, among others, to provide a recreational vehicle which allows a significantly simpler and less risky final assembly of an openable panel to be provided therein.

In order to achieve the stated object a recreational vehicle of the type described in the preamble has the feature according to the invention that the proximal end of the opening device is coupled via a ball joint to the edge of wall opening, that the ball joint comprises a ball head which extends from a one of the opening device and a coupling device, that the ball joint comprises a ball cup which extends from another of the opening device and a coupling device, wherein during operation the ball head is enclosed for radial movement in the ball cup and wherein the ball head is releasable from the ball cup and re-placeable therein under the influence of a force effect exerted manually between the ball cup and ball head. As a result of such an application of a ball joint, also referred to as ball hinge, the coupling between the opening device and the wall of the accommodation can be realized relatively easily by joining the ball head and ball cup together manually. The coupling device applied for the purpose can already be mounted at an early stage on an edge part of the wall adjacent to the wall opening. This can already take place from the moment that a recess for the wall opening has been realized in the wall, and thereby at a relatively early stage of the construction of the accommodation. The final coupling between the opening device and the coupling device can subsequently be realized wholly from outside, i.e. without needing to enter the accommodation for this purpose. This can also be done extremely quickly and without tools being required, since the ball head only has to be placed in the cup for this purpose.

The coupling between the opening device and the coupling device can be realized in various ways. A particular embodiment of the recreational vehicle according to the invention has in this respect the feature that at least one of the ball head and the ball cup is elastically deformable so as to allow release of the ball head from the ball cup and introduction of the ball head into the ball cup. Such a flexibility of the wall of the cup allows a slight yielding thereof and, conversely, an elasticity of the ball head results in a certain compressibility thereof, both of which can afford sufficient play to be able to force the ball head, which is otherwise enclosed in the ball cup, manually therefrom or therein.

A preferred embodiment of the accommodation according to the invention is characterized here in that the ball cup is bounded by a resilient wall. The ball head can thus take a rigid form if desired and the ball cup provides for the deformability required for the purpose of introduction or release of the ball head. This deformability and resilience can be a result of the material applied for the wall of the cup. A particular embodiment of the accommodation according to the invention has in this respect the feature that the wall of the ball cup is formed from a plastic, in particular a plastic selected from a group of polyethylene, polypropylene and polyamide. These plastics are naturally somewhat flexible and a suitable choice of the wall thickness around the ball cup, particularly at a free end thereof, allows the cup opening to yield.

Instead of or together with a choice of material, a resilience of the wall of the ball cup can also be realized in structural manner. A particular embodiment of the accommodation according to the invention has in this context the feature that the wall of the ball cup comprises a number of movable strips, which strips are mutually connected at a base. The wall of the cup can be manufactured here from a plastic, although other materials, such as for instance a metal such as aluminium, are thus also suitable for the ball cup.

A preferred embodiment of the recreational vehicle is characterized in that the ball head extends from the coupling device and the ball cup from the proximal end of the opening device. The spherical ball head thus extends from the coupling device mounted on the edge part of the wall opening, and the ball cup, which in comparison is mechanically more vulnerable, is provided only when the panel with the opening device is arranged.

The invention also relates to an opening device and/or coupling device as applied in the above specified recreational vehicle according to the invention, and will be further elucidated hereinbelow on the basis of an exemplary embodiment and an accompanying drawing. In the drawing:

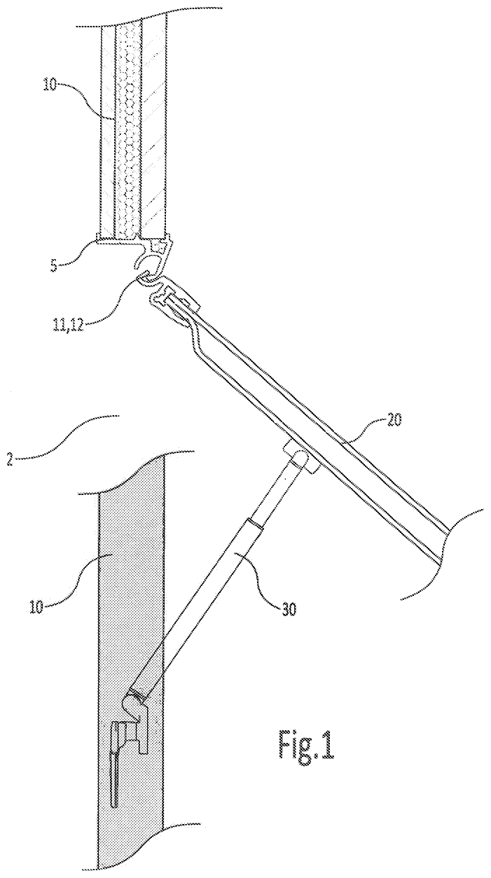

FIG. 1 shows in perspective a part of a wall with an openable window of an exemplary embodiment of a recreational vehicle according to the invention;

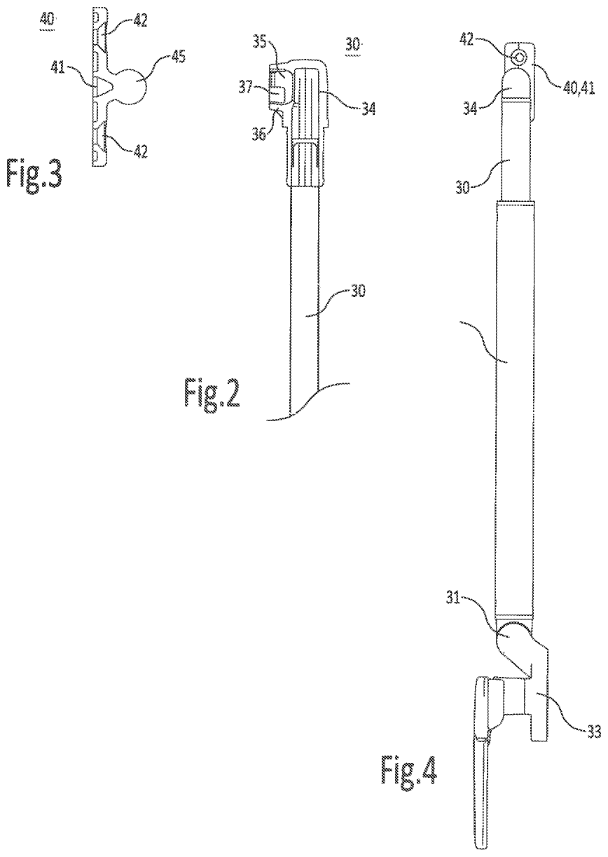

FIG. 2 shows an opening device for use in the recreational vehicle of FIG. 1;

FIG. 3 shows a coupling device for use with the opening device of FIG. 2; and

FIG. 4 shows an assembly of the opening device of FIG. 2 with the coupling device of FIG. 3.

It is otherwise noted that the figures are purely schematic and not always drawn to (the same) scale. Some dimensions in particular may be exaggerated to greater or lesser extent for the sake of clarity. Corresponding parts are designated in the figures with the same reference numeral.

A part of a wall 1 of a caravan is shown in FIG. 1 is as example of a recreational vehicle according to the invention. It will however be apparent that the invention is equally applicable to other types of recreational vehicle and accommodation such as for instance campers (mobile homes), boats and yachts. Insulating sandwich panels are normally applied in the case of a caravan or camper for the walls enclosing one or more accommodation areas. These usually comprise an insulating core of a polymer foam, such as for instance polyurethane foam or polystyrene foam, which is covered on either side with a hard shell part. A weather-resistant aluminium or impact-resistant plastic is often applied here on an outer side, while in the interior a choice is often made for a homely appearance in the form of wood (veneer) or plastic, with or without a wood structure, and an aesthetically inspired colour scheme.

At the location of windows, skylights, luggage hatches, access doors or other openable panels to be formed an opening 2 is provided in the wall at the intended position, for instance by being cut out in the wall by sawing. The thus created opening 2 can as here be provided with a frame 5 for mounting an openable window 20, but can optionally also be embodied with a different edge finish. Situated to the side of opening 2 is a hinge profile 11 for receiving a counter-profile 12 of the window 20 to be hung therein. In this example, wherein a mounting frame 5 is arranged in the opening, hinge profile 11 extends integrally therefrom. In other cases a separate hinge profile is screwed to the relevant side of the opening in wall 1 and/or glued thereto. For both frame 5 and the hinge profile 11 and counter-profile 12 use is normally made of elongate extrusion parts of aluminium which extend over a whole dimension (length or height) of the opening.

In order to be able to open window 20 to different positions and close it an opening device 30 is provided thereon, see also FIG. 2. Opening device 30 comprises two telescopic parts 32,33 which are axially adjustable relative to each other and in which a mutual locking mechanism (not shown) is provided with which the two parts 32,33 can be fixed in successive, discrete or non-discrete length positions relative to each other. At a distal end 33 one of the two parts 31 is connected pivotally to window 20, while at an opposite proximal end 34 the other part 32 is mounted pivotally on the wall of the opening with a coupling device 40. Both the mutually adjustable parts 32,33 are advantageously formed from metal such as aluminium on which plastic shoes are provided at both ends 33,34 from which extend the cup 35 and the attachment to window 20. Suitable plastics for the shoes are in this respect for instance polyethylene, polypropylene and polyamide (nylon).

An example of the coupling device 40 applicable herefor is shown in FIG. 3. This is an aluminium or plastic part 41 having preformed threaded holes 42 therein through which the coupling device can be screwed firmly against wall 1 or frame 5. Extending from coupling device 40 is a ball head 45 which is received for radial movement in a ball cup 35 which extends from proximal end 34 of opening device 30 in order to form a ball joint or ball hinge therebetween. The thus created assembly is shown in FIG. 4.

The walls of ball cup 35 are manufactured from plastic and thereby to some extent resilient. During normal use ball head 45 lies enclosed in ball cup 35 but, if a manual separating force is exerted therebetween, the wall of cup 35 will yield to some extent and release the ball head. Conversely, ball head 45 can be pushed manually into cup 35 with an opposite force effect. Although a solid wall can be applied herefor, wherein the desired flexibility can be imparted by a suitable choice of the wall thickness, particularly at the outer end thereof, the choice is made here for a cup 35 inside a wall which consists of a number of separate strips 36 separated from each other by intermediate grooves 37. These strips are mutually connected at a base but are movable to some extent relative to each other. A greater wall thickness can hereby be applied and other materials can also be applied for the part of the opener 20 with cup 35 without relinquishing the desired resilience thereof which is desirable for being able to introduce ball 45 manually therein or release it therefrom.

The entire finishing of window 20 at the end of the construction of the accommodation can thus take place wholly from outside. To this end the coupling devices 40 are arranged simultaneously with forming of opening 2 and the placing of frame 5, hinge profile 11 and optional further hinges and locks or fittings, such as for instance a latch. The accommodation can then be further fitted out and completed. Window 20 is now provided with the opening device 30 by fixing the distal part 35 thereof permanently to window 20. Counter-profile 12 of the window hinge is also mounted on the window. Finally, window 20 now need only be hung from outside in hinge profile 11, and ball head 45 pushed into ball cup 35. It is not necessary to enter the accommodation for this purpose. The same applies for a possible replacement of window 20 after a period of time.

Although the invention has been further elucidated above with reference to only a single exemplary embodiment, it will be apparent that the invention is by no means limited thereto. On the contrary, many variations and embodiments are still possible within the scope of the invention for a person with ordinary skill in the art.

1. Recreational vehicle comprising a space enclosed by walls, wherein at least one of the walls is provided with a wall opening recessed therein and surrounded by an edge with an openable panel which is adjustable between a closed state closing off the opening and at least one wholly or partially opened state, which panel is provided with at least one opening device with which the panel is fixable in the at least one wholly or partially opened state, wherein the opening device comprises a proximal end and an opposite distal end and is connected at the distal end to the window, characterized in that the proximal end of the opening device is coupled via a ball joint to the edge of wall opening, that the ball joint comprises a ball head which extends from a one of the opening device and a coupling device, that the ball joint comprises a ball cup which extends from another of the opening device and a coupling device, wherein during operation the ball head is enclosed for radial movement in the ball cup and wherein the ball head is releasable from the ball cup and re-placeable therein under the influence of a force effect exerted manually between the ball cup and ball head.

2. Recreational vehicle as claimed in claim 1, characterized in that at least one of the ball head and the ball cup is elastically deformable so as to allow release of the ball head from the ball cup and introduction of the ball head into the ball cup.

3. Recreational vehicle as claimed in claim 2, characterized in that the ball cup is bounded by a resilient wall.

4. Recreational vehicle as claimed in claim 3, characterized in that the wall of the ball cup is formed from a plastic, in particular a plastic selected from a group of polyethylene, polypropylene and polyamide.

5. Recreational vehicle as claimed in claim 3, characterized in that the wall of the ball cup comprises a number of movable strips, which strips are mutually connected at a base.

6. Recreational vehicle as claimed in claim 1, characterized in that the ball head extends from the coupling device and the ball cup from the proximal end of the opening device.

7. Opening device and/or coupling device of the type as applied in the recreational vehicle as claimed in claim 1.
